(19) United States
(12) Patent Application Publication
(10) Pub. No.: US 2024/0421690 A1
(43) Pub. Date: Dec. 19, 2024

(54) DYNAMIC MINIMUM OFF-TIME FOR SWITCHING REGULATOR

(71) Applicant: Texas Instruments Incorporated, Dallas, TX (US)

(72) Inventors: Liang Zhang, Bejing (CN); Xinyu Yin, Bejing (CN); Yutao Wang, Bejing (CN)

(21) Appl. No.: 18/333,974

(22) Filed: Jun. 13, 2023

(51) Int. Cl. H02M 1/088; H02M 3/158

(52) U.S. Cl. CPC H02M 1/088; H02M 3/158

(57) ABSTRACT

A circuit configured to adjust a minimum off-time for a switching element in a power converter. In an example, a controller includes a pulse width modulation (PWM) circuit and a timing adjustment circuit. The PWM circuit is configured to determine switching element off-time based on a received feedback signal and a minimum off-time control signal. The received feedback signal may be proportional to an output voltage of the power converter. The timing adjustment circuit includes a comparator, wherein a first comparator input is configured to receive a sample voltage that changes based on the output voltage of the power converter, and a second comparator input is configured to receive a reference voltage. The comparator provides the minimum off-time control signal at its output and is configured to adjust the minimum off-time control signal based on a length of time that the sample voltage is less than the reference voltage.

### TECHNICAL FIELD

This description relates to power converters, and more particularly, to adjusting a minimum off-time for switching elements in a switching regulator.

### BACKGROUND

Power converters (such as DC-DC converters) are widely used in electronic systems such as consumer electronics, automotive systems, industrial equipment, lighting systems, etc. for converting an input voltage to an output voltage higher or lower than the input voltage. Such converters utilize a switching transistor (e.g., metal oxide semiconductor field effect transistor, or MOSFET) that turns on and off to regulate the output voltage. A feedback loop along with a controller is also used to determine the on or off-time of the transistor in each switching cycle based on the feedback voltage and a reference voltage, thereby regulating the output voltage of the power converter. There are a number of non-trivial issues with providing a stable output voltage in view of the transistor switching times.

### SUMMARY

According to an embodiment, a controller is described that is designed to determine an off time for a switching element of a power converter circuit. The controller includes a pulse width modulation circuit configured to determine the off-time of the switching element based on a received feedback signal and a minimum off-time control signal, and a timing adjustment circuit that includes a comparator having first and second comparator inputs and a comparator output. The received feedback signal is proportional to a voltage at an output voltage terminal of the power converter circuit. The first comparator input is configured to receive a sample voltage that changes based on the voltage at the output voltage terminal of the power converter circuit, and the second comparator input is configured to receive a reference voltage. The comparator output provides the minimum off-time control signal. The comparator is configured to adjust the minimum off-time control signal based on a length of time that the sample voltage is less than the reference voltage.

According to another embodiment, a voltage regulator includes a first voltage rail, a second voltage rail, a ground rail, a first transistor coupled between the first voltage rail and a switching node terminal, a first driver coupled to a control terminal of the first transistor and configured to receive a voltage on the second voltage rail, a second transistor coupled between the switching node terminal and the ground rail, a second driver coupled to a control terminal of the second transistor, and a timing adjustment circuit configured to generate a minimum off-time control signal for dynamically adjusting a minimum off-time for the first transistor. The timing adjustment circuit incudes a comparator having a first input configured to receive a sample voltage that changes based on a voltage at the switching node terminal, a second input configured to receive a reference voltage, and an output that provides the minimum off-time control signal. The minimum off-time control signal has a state that is based on a length of time that the sample voltage is less than the reference voltage

According to another embodiment, a timing adjustment circuit is described for use within a voltage converter. The timing adjustment circuit includes a filter circuit configured to receive a switching node terminal voltage of the voltage converter and generate a direct current (DC) voltage proportional to an output voltage of the voltage converter, an operational amplifier (op-amp) having an op-amp output and first and second op-amp inputs. The first op-amp input is configured to receive the DC voltage. The timing adjustment circuit also includes a first transistor having a control terminal coupled to the output of the operational amplifier, a first current terminal coupled to the second op-amp input, and a second current terminal. The timing adjustment circuit also includes a capacitor having a first terminal and a second terminal, a current mirror circuit coupled between a voltage supply terminal and the second current terminal of the first transistor and also coupled between the voltage supply terminal and the first terminal of the capacitor, a second transistor coupled between the first and second terminals of the capacitor, and a comparator having a comparator output and first and second comparator inputs. The first comparator input is coupled to the first terminal of the capacitor, and the second comparator input is coupled to a reference voltage source, such that the comparator output provides a logic HIGH responsive to a voltage at the first comparator input being higher than a voltage at the second comparator input, and the comparator output provides a logic LOW responsive to a voltage at the first comparator input being lower than the voltage at the second comparator input.

### BRIEF DESCRIPTION OF THE DRAWINGS

FIG. 1 is a block diagram of a voltage regulator, in an example.

FIG. 2A is a block diagram showing a controller of the voltage regulator illustrated in FIG. 1, in an example.

FIG. 2B is a timing diagram of various signals associated with a pulse control block of the controller illustrated in FIG. 2A, in an example.

FIG. 3 is a block diagram of a timing adjustment circuit of the controller illustrated in FIG. 2A, in an example.

FIG. 4 is a schematic diagram of the timing adjustment circuit illustrated in FIG. 3, in an example.

FIG. 5 provides a timing diagram of various signals associated with the timing adjustment circuit illustrated in FIG. 4, in an example.

FIG. 6 provides a graph of different minimum off-times generated by a timing adjustment circuit for different output voltages, in an example.

FIG. 7A provides a graph of output voltage and output current for different parasitic capacitance values without the use of a timing adjustment circuit.

FIG. 7B provides a graph of output voltage and output current for different parasitic capacitance values with the use of a timing adjustment circuit, in an example.

### DETAILED DESCRIPTION

Techniques are described for adjusting a minimum off-time for a switching element in a power converter. According to some embodiments, the techniques can be implemented in a timing adjustment system. In some such examples, the system is configured to adjust the minimum allowed off-time for the high-side switching element of a power converter (e.g., a DC-DC buck converter). The timing adjustment system may include a timing adjustment circuit within a controller that generates the pulse width modulation (PWM) signals used to turn on and off both the high-side switching element and a low-side switching element. The high and low-side switching elements regulate whether a switching node terminal is coupled to an input power rail or a ground rail, and their respective on-times dictate the output voltage level. The high and low-side switching elements are alternately activated such that the high-side switching element is on while the low-side switching element is off, and vice versa. A feedback loop is provided to sample the output voltage and provide it back to the controller, and the controller can use that feedback to set the appropriate on-time for the high-side switching element to bring the output voltage to a desired voltage output.

According to some such embodiments, the timing adjustment circuit samples the output switching voltage of the power converter and converts this sampled voltage into a sample current. A current mirror may be used to provide a mirrored current (e.g., roughly equal to the sample current) that charges a capacitor during periods of time that the high-side switching element is off. The voltage across the capacitor is compared to a reference voltage by a comparator, where the output of the comparator remains LOW while the capacitor voltage is less than the reference voltage. Responsive to the capacitor having charged long enough such that the capacitor voltage exceeds the reference voltage, the output of the comparator switches HIGH. The comparator output may be used to override the feedback operation used by the controller that determines when to turn on the high-side switching element, by forcing the high-side switching element to remain off, at least until the voltage across the capacitor exceeds the reference voltage. Accordingly, a minimum off-time for the high-side switching element may be dynamically adjusted based on the output voltage level. For example, for decreasing output voltages the minimum off-time may be increased, respectively.

### General Overview

As described above, a number of non-trivial issues are associated with providing a stable output voltage in view of transistor (e.g., MOSFET) switching times within a power converter. For example, a minimum off-time is often used by a controller that controls the PWM signals for the high-side and low-side MOSFET switches to support a large duty cycle and improve load transient performance. Accordingly, the minimum off-time is set to be as low as possible (e.g., around 50 ns). However, problems arise with the low minimum off-time in situations where lower output voltages are desired. For example, a desired output voltage of less than two volts may result in the output voltage terminal not charging high enough due to parasitic capacitance within the circuit or circuit package. This parasitic capacitance may exist, for example, between the output terminal and feedback terminal of the power converter. Since the feedback voltage is also affected, it drops as well and is not able to recover due to the minimum off-time being too short. As a result, the high-side switch turns on for too long and the output voltage becomes unstable. A longer minimum off-time for the high-side switch can correct this problem, but this causes noise and other instability issues when the desired output voltage is high (e.g., closer to the input voltage of the power converter). In such situations, keeping the minimum off-time shorter may be advantageous.

Thus, techniques are described herein for dynamically adjusting off-time of a power converter switching element (e.g., MOSFET). In an example, a timing adjustment system is described that may be integrated with the controller of a power converter to dynamically change the minimum off-time of the high-side switch based at least in part on the output voltage. The timing adjustment system may include a circuit within the controller itself or coupled to the controller that includes a sampling block, an amplifier block, a charging block, and a comparator block at the output. According to some embodiments, the sampling block may be designed to sample the switching node voltage of the power converter and use any number of resistor-capacitor (RC) filters to average the switching node voltage and provide an average output voltage (V_{CSN}). The average output voltage may be fed into an input of the amplifier block (e.g., an operational amplifier) to generate a drive voltage (V_{DRV}). According to some embodiments, the charging block may include a MOSFET having a gate terminal that receives V_{DRV} to generate a related current (I₁) through a resistor (R). A current mirror within the charging block may be used to provide a mirrored current (I₂) substantially the same as I₁ to charge a capacitor (C) only during times that the high-side switch is off (and the low-side switch is respectively on). The voltage on the capacitor may be received by a first input of the comparator block while a second input of the comparator block receives a reference voltage. The output of the comparator block determines the minimum off-time of the high-side switch and remains LOW as long as the voltage across the capacitor remains below the reference voltage. The comparator block output may be used to override the output of the feedback loop (e.g., by using logic, such as an AND-gate) used by the controller to determine the on-time for the high-side switch. Numerous other variations will be apparent based on the embodiments described herein.

### Electronic System

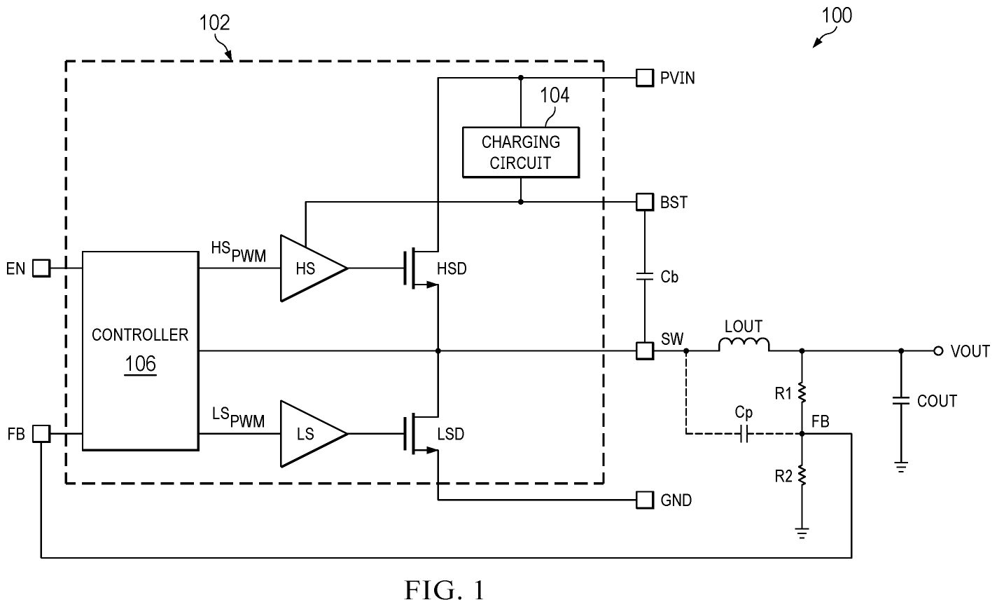

FIG. 1 illustrates at least a portion of an example electronic system 100. In some cases, electronic system 100 is implemented as a system-on-chip, or as a chip set populated on a printed circuit board (PCB), or as a set of discrete components populated on a PCB, which may in turn be populated into a chassis of a multi-chassis system or an otherwise higher-level system, although any number of implementations can be used. Electronic system 100 may be part of a switching regulator or power converter such as a DC-DC buck switching converter.

According to some embodiments, electronic system 100 includes a power converter circuit 102, which may be implemented as a chip within a chip package and may have various input/output (I/O) terminals, such as an enable terminal (EN), a power input terminal (PVIN), a bootstrap terminal (BST), a switching node terminal (SW), a ground terminal (GND), and a feedback terminal (FB). Any number of other I/O terminals may be provided.

According to some embodiments, power converter circuit 102 includes a high-side switching element (HSD) along with an associated high-side driver (HS), and a low-side switching element (LSD) along with an associated low-side driver (LS). As shown in FIG. 1, both high-side switching element HSD and low-side switching element LSD may be n-channel MOSFETs, although other suitable switching elements may be used. High-side switching element HSD has a first terminal coupled to an input power rail (e.g., PVIN terminal) and a second terminal coupled to the switching node SW of the power converter. Accordingly, the state of high-side driver HS controls the gate terminal of high-side switching element HSD and high-side switching element HSD provides the input voltage on PVIN to switching node SW when the high-side switching element HSD is on. Low-side switching element LSD has a first terminal coupled to the switching node SW and a second terminal coupled to a ground rail (e.g., at ground terminal GND). Accordingly, the state of low-side driver LS controls the gate terminal of low-side switching element LSD and low-side switching element LSD provides a ground voltage to switching node SW when the low-side switching element LSD is on. Only one of HSD and LSD is on at any given time and LSD is off whenever HSD is on and vice versa.

A boost capacitor Cb may be coupled between the switching node SW and bootstrap terminal BST (or a bootstrap voltage rail) and can be used to provide a boosted voltage that is higher than the output switching voltage at SW in conjunction with a bootstrap charging circuit 104 (e.g., used to charge Cb) between bootstrap terminal BST and input voltage terminal PVIN. This boosted voltage may then be provided to the positive supply rail of the high-side driver HS.

An inductor LOUT may be provided at the switching node SW to smooth out the changing voltage and provide a more stable output voltage as VOUT. In some cases, inductor LOUT may be, for example, part of a transformer, or any other suitable energy storage element. A voltage divider that includes resistors R1 and R2 may be provided at the output to generate a feedback voltage that is fed to feedback terminal FB of power converter circuit 102.

A controller 106 provides control signals (e.g., HS_{PWM} and LS_{PWM}) to the inputs of high-side driver HS and low-side driver LS, respectively. These control signals may be pulse width modulated signals that drive the respective high-side and low-side switching elements. Controller 106 may also receive various inputs (e.g., feedback voltage FB, switching node voltage SW, and an enable signal EN) to facilitate the generation of the control signals.

According to some embodiments, a parasitic capacitance Cp can exist between the switching node SW and the feedback terminal FB. This parasitic capacitance can cause problems by dropping the feedback voltage too quickly and causing an unstable output voltage VOUT, which can be more noticeable for lower VOUT values (e.g., less than 2 volts). Thus, in accordance with some embodiments, controller 106 may include (or be coupled to) a timing adjustment system that is designed to dynamically change the minimum off-time of the high-side switching element HSD, thus giving the feedback voltage at FB more time to recover during lower VOUT operation.

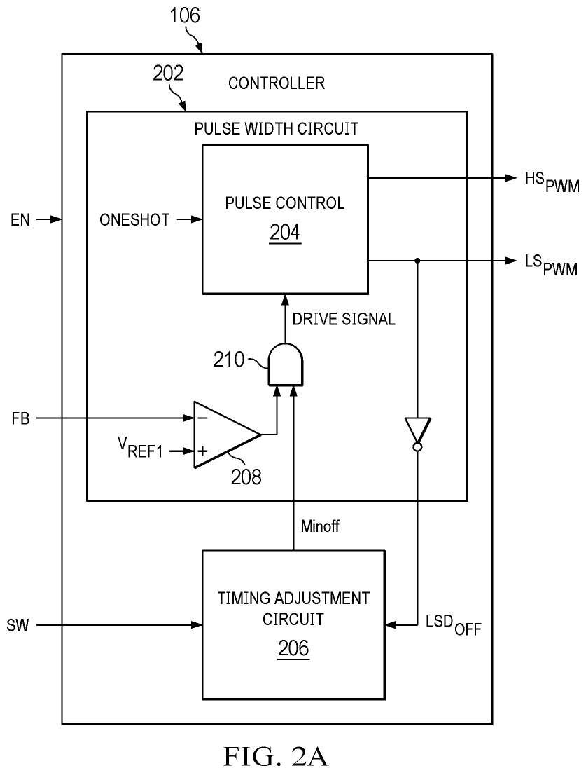

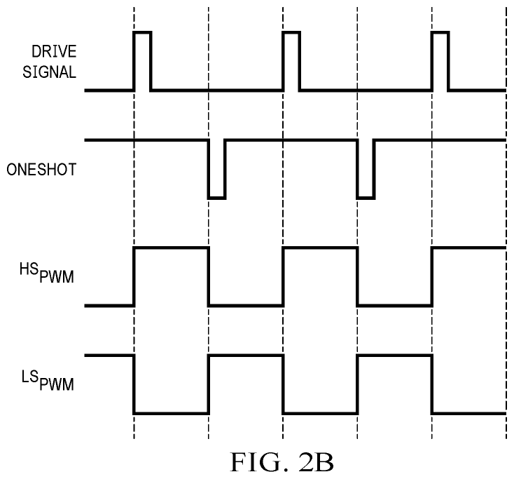

FIG. 2A illustrates a diagram of controller 106, according to some embodiments. Controller 106 includes a pulse width modulation circuit 202, which may include a pulse control block 204 that generates the PWM control signals for both the high-side and low-side drivers. Controller 106 also includes a timing adjustment circuit that produces a Minoff signal to control a minimum off-time for the HS_{PWM} control signal.

Pulse control block 204 determines the on-time and duty cycle for the PWM control signals based at least in part on the state of a ONESHOT signal and a Drive Signal. FIG. 2B illustrates an example timing diagram illustrating how these signals are used to generate the PWM control signals. According to some embodiments, when the Drive Signal pulses HIGH, the HS_{PWM} signal is asserted high to turn on the high-side switching element HSD. The HS_{PWM} signal will remain HIGH until ONESHOT pulses LOW, at which point the HS_{PWM} signal is asserted LOW to turn off the high-side switching element HSD. The HS_{PWM} signal will remain LOW until the Drive Signal pulses HIGH again to repeat the cycle. Accordingly, the Drive Signal controls when the high-side switching element is turned on and ONESHOT determines the duty cycle by controlling how long HS_{PWM} remains HIGH. The LS_{PWM} signal is the inverse of the HS_{PWM} signal to ensure correct switching operation of the high-side and low-side switching elements.

Returning to FIG. 2A, in cases where the Minoff signal is asserted HIGH, the state of Drive Signal is determined by comparing the feedback voltage at FB to a first reference voltage (V_{REF1}) at a comparator 208. Accordingly, Drive Signal will pulse high when the feedback voltage falls below V_{REF1}, thus turning the high-side switching element HSD back on. According to some embodiments, the output of comparator 208 from the feedback loop may be effectively overwritten (or otherwise neutralized) by the Minoff signal via the utilization of an AND-gate 210. In this way, as long as the Minoff signal is asserted LOW, the output of comparator 208 will not matter and the Drive Signal will remain LOW. Only when the Minoff signal is HIGH will the output of comparator 208 be able to control the state of the Drive Signal, according to some embodiments.

According to some embodiments, timing adjustment circuit 206 receives the switching node voltage at terminal SW and also an LSD_{OFF} signal which may be the inverse of the LS_{PWM} signal, such that when the low-side switching element is off, LS_{PWM} is LOW and LSD_{OFF} is HIGH. Accordingly, timing adjustment circuit 206 may adjust the length of time that Minoff remains LOW based on the output switching voltage at terminal SW. The LSD_{OFF} signal may be used by timing adjustment circuit 206 to indicate the current state of the high-side and low-side switching elements such that adjustments to the Minoff signal occur during the period of time when the high-side switching element HSD is off.

### Timing Adjustment Circuit

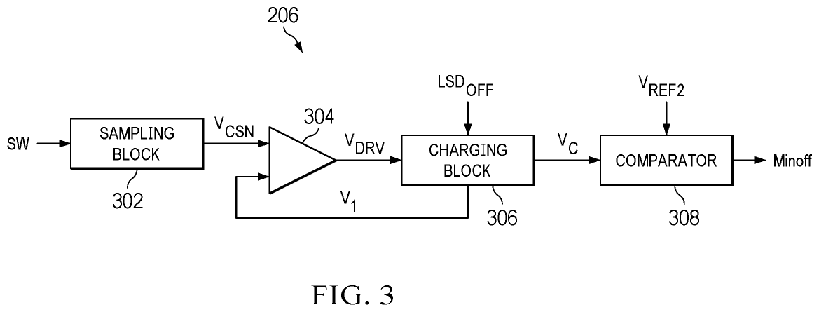

FIG. 3 illustrates a block diagram of timing adjustment circuit 206, according to some embodiments. Timing adjustment circuit 206 includes a sampling block 302, an amplifier 304, a charging block 306, and a comparator 308. According to some embodiments, sampling block 302 receives the output switching voltage at the SW terminal and filters the switching voltage to produce an average output voltage value V_{CSN}. The voltage V_{CSN} is received at an input terminal of amplifier 304, which may be an operational amplifier, to produce a drive voltage V_{DRV}. According to some embodiments, drive voltage V_{DRV} is converted to a drive current within charging block 306. This drive current may be used to generate a feedback voltage V1 that is also received by another input terminal of amplifier 304. According to some embodiments, the drive current is mirrored to produce a similar current that charges a capacitor during times when the high side switching element is off. The voltage across the capacitor Vc may be fed to a first input of comparator 308 while a second input of comparator 308 receives a second voltage reference V_{REF2}. The output of comparator 308 produces the Minoff signal which is LOW during times when the capacitor voltage Vc is less than the second reference voltage V_{REF2}.

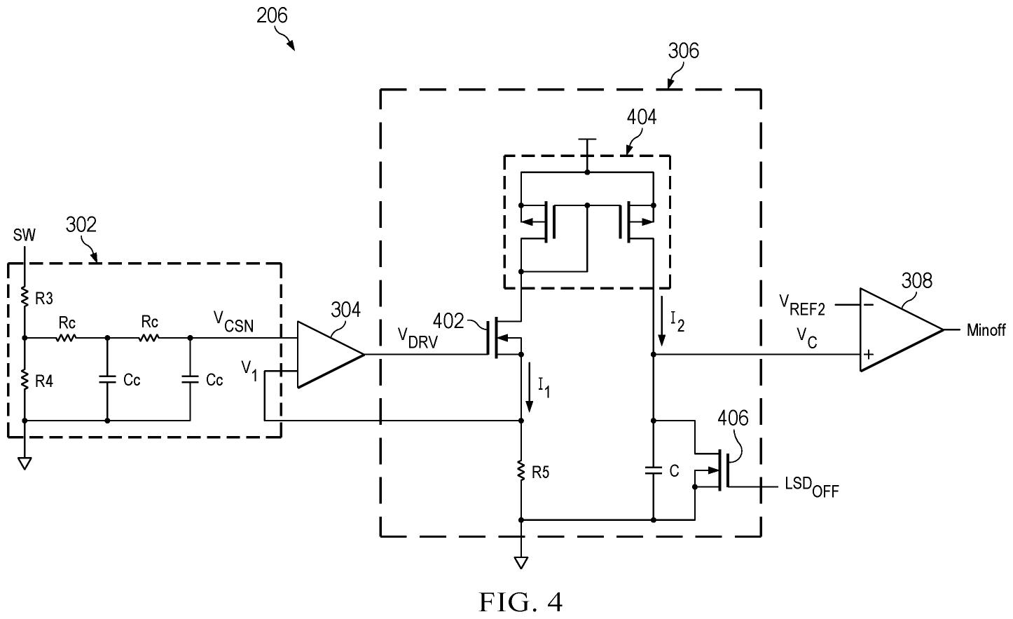

FIG. 4 illustrates a schematic diagram of timing adjustment circuit 206, according to an embodiment. Sampling block 302 may include a voltage divider with resistors R3 and R4 along with any number of RC filters to produce a voltage V_{CSN} that is proportional to the output voltage VOUT. The voltage V_{CSN} may be a DC (or nearly a DC) voltage that represents an average of the voltage at the switching node terminal SW. In some embodiments, the RC filter network is a ripple filter. In some embodiments, the RC filters include any number of low-pass filters. Due to the presence of the voltage divider, V_{CSN} is roughly equal to (or at least proportional to) VOUT/N, where N=(R3+R4)/R4.

According to some embodiments, V_{CSN} is received at a first input of amplifier 304. The output of amplifier 304 is coupled to a gate terminal of a first FET 402. In some embodiments, first FET 402 is an n-channel device. Accordingly, the output voltage of amplifier 304 is converted into a drive current I₁ that flows through the source and drain terminals of first FET 402. According to some embodiments, a feedback voltage V₁ may be created from the drive current I₁ through resistor R5. The feedback voltage V₁ may then be fed into a second input of amplifier 304. According to some embodiments, the feedback voltage V₁ is roughly equal to V_{CSN}. Furthermore, the drive current I₁ is roughly equal to VOUT/(N*R5). In some embodiments, amplifier 304 acts as a unity gain buffer with a gain of around 1.

According to some embodiments, charging block 306 includes a current mirror 404 to produce a mirrored current I₂ that is roughly equal to I₁. In some examples, current mirror 404 includes p-channel FETs. According to some embodiments, the mirrored current I₂ charges a capacitor C during periods of time that the high-side switching element HSD is off. Accordingly, a second FET 406 may be coupled across the terminals of capacitor C with the gate of second FET 406 configured to receive the LSD_{OFF} signal. In some embodiments, second FET 406 is an n-channel device. If the low-side switching element LSD is off (e.g., LSD_{OFF} is HIGH) then second FET 406 is turned on and bypasses capacitor C since the high-side switching element HSD is on. However, whenever the high-side switching element HSD is off, LSD_{OFF} will be LOW and the mirrored current I₂ can charge capacitor C. It should be understood that any number of other circuits could be utilized to bypass capacitor C during periods of time that the high-side switching element HSD is on. For example, the control terminal of second FET 406 may be configured to receive an HSD_{ON} signal to indicate when the high-side switching element HSD is on, or a p-channel device may be used along with the corresponding control signal to indicate that the high-side switching element HSD is on.

According to some embodiments, a sample voltage V_{C} is created at capacitor C due to the charging from the mirrored current I₂. Thus, the sample voltage V_{C} steadily increases as capacitor C is charged. Comparator 308 receives sample voltage V_{C} at a positive input terminal and receives the second voltage reference V_{REF2} at a negative input terminal. According to some embodiments, the output of comparator 308 (Minoff) remains low while V_{C} is charging up towards the level of V_{REF2} and becomes HIGH when V_{C} surpasses V_{REF2}. As long as Minoff remains low, the high side switching element HSD cannot be turned on, thus setting the minimum off-time for the high side switching element HSD. According to some embodiments, the length of time that Minoff remains low (e.g., the minimum off-time) is roughly equal to (N*R*C)*(V_{REF2}/VOUT). Accordingly, the minimum off-time dynamically changes in response to changes in VOUT. According to some embodiments, the second reference voltage V_{REF2} may be a static value to affect a maximum length of time for Minoff for a given output voltage, or V_{REF2} may be configurable (e.g., by a user) to adjust the maximum level of the minimum off-time for a given output voltage.

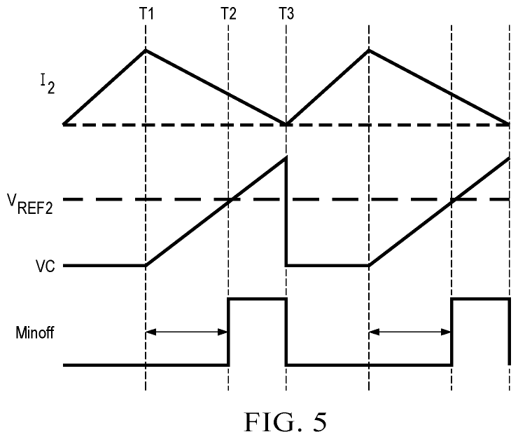

FIG. 5 illustrates a timing diagram for various signals within timing adjustment circuit 206, according to some embodiments. Up until a first time T1, the high side switching element HSD is ON and VOUT is increasing causing a corresponding increase of I₂. During this time, capacitor C is bypassed due to LSD_{OFF} being HIGH so V_{C} is grounded and Minoff is LOW. At time T1, the high-side switching element HSD turns off, which begins to decrease VOUT and allows the capacitor C to charge. Accordingly, V_{C} begins to increase and continues to increase until the high-side switching element HSD turns on again. At time T2, V_{C} has increased beyond the level of V_{REF2} and Minoff is asserted HIGH. At time T3, the high-side switching element HSD is turned ON again, thus brining Minoff back to LOW and pulling V_{C} to ground.

According to some embodiments, time between T1 and T2 is equivalent to the minimum off-time for the high-side switching element HSD. During this time, the high-side switching element HSD is forced to remain off and can only be turned on when Minoff is asserted HIGH.

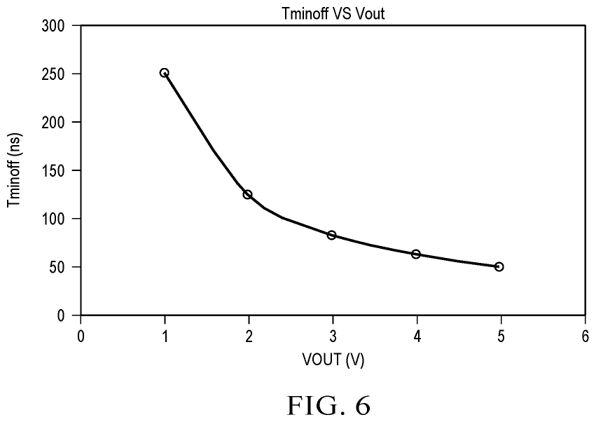

FIG. 6 illustrates a graph showing some example values of minimum off-times (Tminoff) provided by timing adjustment circuit 206 based on different output voltages VOUT. The minimum off-time increases as the output voltage decreases due to a slower charging speed across the capacitor C. Conversely, higher voltages result in a faster charging of capacitor C and a lower minimum off-time. In some embodiments, the minimum off-time may not fall below a threshold value, such as around 50 ns.

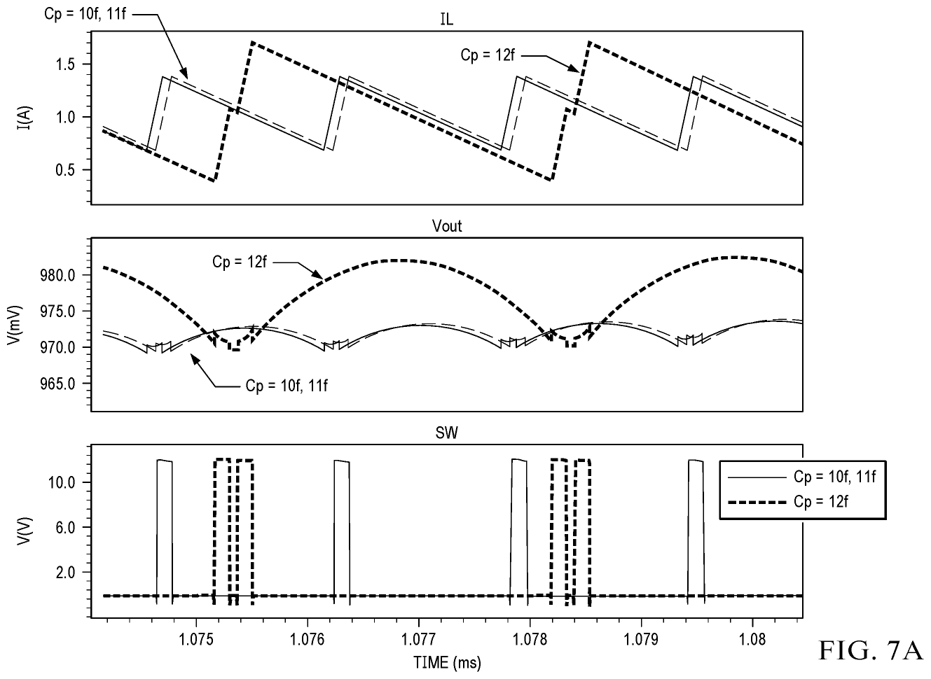

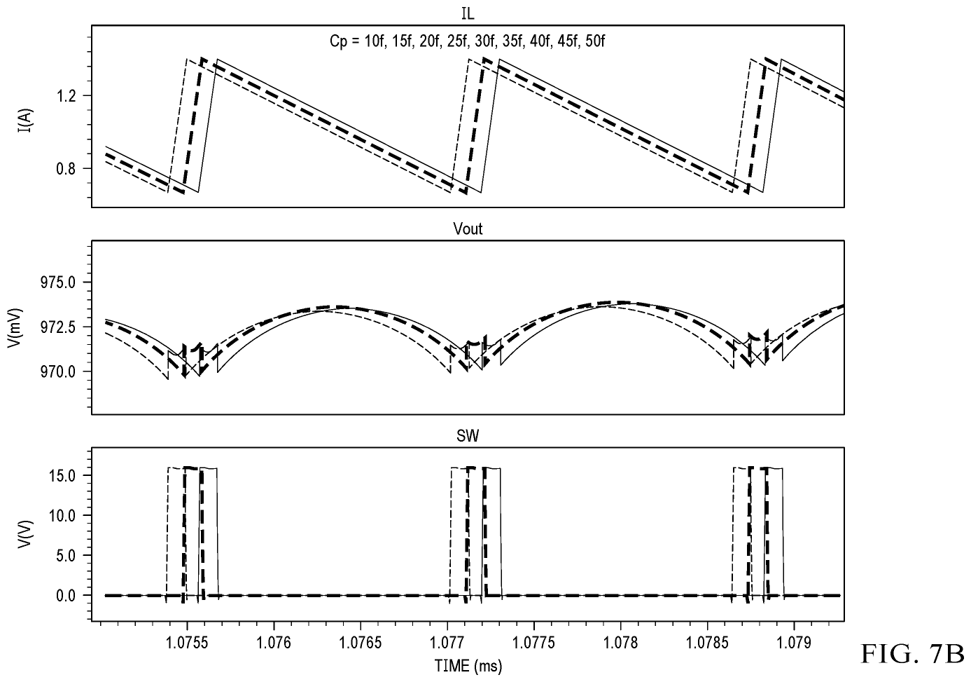

FIG. 7A shows a graph of various power converter output signals that highlight the problem when timing adjustment circuit 206 is not used. The various graphs show the current output of the power converter (I), the DC output voltage (VOUT), and the switching node voltage (SW). As can be seen, for instances of high parasitic capacitance (e.g., Cp is 12 F or greater), the output of the power converter becomes unstable as the high side switching element HSD is turning back on too quickly for the feedback to keep up. This results in the DC output voltage swinging too widely.

FIG. 7B shows a graph of the same various power converter output signals from FIG. 7A that highlight improved performance when the timing adjustment circuit 206 is used. Here, parasitic capacitance values as high as 50 F are used and exhibit stable operation. The output voltage VOUT remains steady by preventing the high side switching element HSD from turning on too quickly during a lower VOUT operation.

### FURTHER EXAMPLES

Example 1 is a controller configured to determine an off-time for a switching element of a power converter circuit. The controller includes a pulse width modulation circuit and a timing adjustment circuit. The pulse width modulation circuit is designed to determine the off-time of the switching element based on a received feedback signal and a minimum off-time control signal. The received feedback signal is proportional to a voltage at an output voltage terminal of the power converter circuit. The timing adjustment circuit includes a comparator having first and second comparator inputs and a comparator output. The first comparator input is configured to receive a sample voltage that changes based on the voltage at the output voltage terminal of the power converter circuit, and the second comparator input is configured to receive a reference voltage. The comparator output provides the minimum off-time control signal. The comparator is configured to adjust the minimum off-time control signal based on a length of time that the sample voltage is less than the reference voltage.

Example 2 includes the controller of Example 1, wherein the timing adjustment circuit further comprises a sampling block configured to generate an intermediate voltage proportional to an average of a voltage at a switching node terminal of the power converter circuit.

Example 3 includes the controller of Example 2, wherein the comparator is a first comparator and the reference voltage is a first reference voltage, and the pulse width modulation circuit comprises a second comparator having a first input configured to receive the feedback signal, a second input configured to receive a second reference voltage, and an output.

Example 4 includes the controller of Example 3, wherein the pulse width modulation circuit further comprises an AND-gate having a first AND-gate input coupled to the output of the second comparator, a second AND-gate input coupled to the output of the first comparator, and an AND-gate output coupled to a pulse control block.

Example 5 includes the controller of any one of Examples 2-4, wherein the sampling block comprises one or more low-pass filter stages.

Example 6 includes the controller of any one of Examples 2-5, wherein the timing adjustment circuit further comprises an amplifier configured to generate a drive current proportional to the intermediate voltage.

Example 7 includes the controller of Example 6, wherein the timing adjustment circuit further comprises a current mirror arrangement configured to generate a mirrored current based on the drive current.

Example 8 includes the controller of Example 7, wherein the timing adjustment circuit further comprises a capacitor configured to be charged by the mirrored current, and wherein a first terminal of the capacitor is coupled to both the current mirror arrangement and the first input of the comparator, and a second terminal of the capacitor is coupled to a ground terminal.

Example 9 includes the controller of Example 8, wherein the timing adjustment circuit further comprises a transistor coupled across the first and second terminals of the capacitor.

Example 10 includes the controller of Example 8 or 9, wherein a charging rate of the capacitor is proportional to the voltage at the output voltage terminal.

Example 11 is an integrated circuit comprising the controller of any one of Examples 1-10.

Example 12 is a power converter circuit that includes the controller of any one of Examples 1-10, the switching element, and a driver having an output coupled to a control terminal of the switching element.

Example 13 includes the power converter circuit of Example 12, wherein the timing adjustment circuit further comprises a sampling block, an amplifier, a current mirror arrangement, a capacitor, and a transistor. The sampling block is configured to generate an intermediate voltage proportional to an average of a voltage at a switching node terminal of the power converter circuit. The amplifier is configured to generate a drive current proportional to the intermediate voltage. The current mirror arrangement is configured to generate a mirrored current based on the drive current. The capacitor is configured to be charged by the mirrored current. A first terminal of the capacitor is coupled to both the current mirror arrangement and the first input of the comparator, and a second terminal of the capacitor is coupled to a ground terminal. The transistor is coupled across the first and second terminals of the capacitor. The transistor bypasses the capacitor during periods when the switching element is on, and the transistor does not by-pass the capacitor during periods when the switching element is off.

Example 14 includes the power converter circuit of Example 12 or 13, wherein the switching element is a high-side switching element and the driver is a first driver. The power converter circuit further comprises a low-side switching element coupled in series with the high-side switching element, and a second driver having an output coupled to a control terminal of the low-side switching element.

Example 15 includes the power converter circuit of Example 14, wherein an on-time for the low-side switching element is substantially equal to the off-time for the high-side switching element.

Example 16 is a voltage regulator that includes a first voltage rail, a second voltage rail, a ground rail, a first transistor coupled between the first voltage rail and a switching node terminal, a first driver coupled to a control terminal of the first transistor and configured to receive a voltage on the second voltage rail, a second transistor coupled between the switching node terminal and the ground rail, a second driver coupled to a control terminal of the second transistor, and a timing adjustment circuit. The timing adjustment circuit is configured to generate a minimum off-time control signal for dynamically adjusting a minimum off-time for the first transistor. The timing adjustment circuit includes a comparator having a first input configured to receive a sample voltage that changes based on a voltage at the switching node terminal, a second input configured to receive a reference voltage, and an output that provides the minimum off-time control signal. The minimum off-time control signal has a state that is based on a length of time that the sample voltage is less than the reference voltage.

Example 17 includes the voltage regulator of Example 16, wherein the timing adjustment circuit further comprises a sampling block configured to generate an intermediate voltage proportional to an average of the voltage at the switching node terminal.

Example 18 includes the voltage regulator of Example 17, wherein the sampling block comprises one or more resistor-capacitor (RC) filter stages.

Example 19 includes the voltage regulator of Example 17 or 18, wherein the timing adjustment circuit further comprises an amplifier configured to generate a drive current proportional to the intermediate voltage.

Example 20 includes the voltage regulator of Example 19, wherein the timing adjustment circuit further comprises a current mirror circuit configured to generate a mirrored current based on the drive current.

Example 21 includes the voltage regulator of Example 20, wherein the timing adjustment circuit further comprises a capacitor configured to be charged by the mirrored current at a first terminal, and wherein the first terminal of the capacitor is coupled to the first input of the comparator and a second terminal of the capacitor is coupled to the ground rail.

Example 22 includes the voltage regulator of Example 21, wherein the timing adjustment circuit further comprises a third transistor coupled across the first terminal of the capacitor and the second terminal of the capacitor.

Example 23 includes the voltage regulator of Example 21 or 22, wherein a charging rate of the capacitor is proportional to the voltage at the switching node terminal.

Example 24 includes the voltage regulator of any one of Examples 16-23, wherein an on-time for the first transistor is substantially equal to an off-time for the second transistor.

Example 25 includes the voltage regulator of any one of Examples 16-24, further comprising a pulse width modulation circuit configured to determine an off-time of the first transistor based on a received feedback signal proportional to a voltage at the switching node terminal and on the output of the comparator, wherein the off-time cannot be lower than the minimum off-time.

Example 26 includes the voltage regulator of any one of Examples 16-25, wherein the first voltage rail is an input voltage rail, the second voltage rail is a bootstrapped voltage rail, the first transistor is a high-side transistor, and the second transistor is a low-side transistor.

Example 27 is a timing adjustment circuit for use within a voltage converter. The timing adjustment circuit includes a filter circuit, an operational amplifier (op-amp) having an op-amp output and first and second op-amp inputs, a first transistor having a control terminal and first and second current terminals, a capacitor having a first terminal and a second terminal, a current mirror circuit, a second transistor coupled between the first and second terminals of the capacitor, and a comparator having a comparator output and first and second comparator inputs. The filter circuit is configured to receive a switching node terminal voltage of the voltage converter and generate a direct current (DC) voltage. The first op-amp input is configured to receive the DC voltage. The control terminal of the first transistor is coupled to the output of the operational amplifier, and the first current terminal of the first transistor is coupled to the second op-amp input. The current mirror circuit is coupled between a voltage supply terminal and the second current terminal of the first transistor, and is also coupled between the voltage supply terminal and the first terminal of the capacitor. The first comparator input is coupled to the first terminal of the capacitor, and the second comparator input is coupled to a reference voltage source. The comparator output provides a logic HIGH responsive to a voltage at the first comparator input being higher than a voltage at the second comparator input, and the comparator output provides a logic LOW responsive to a voltage at the first comparator input being lower than the voltage at the second comparator input.

Example 28 includes the timing adjustment circuit of Example 27, wherein the DC voltage is proportional to an output voltage of the voltage converter. In one such example, the DC voltage is proportional to an average level of the switching node terminal voltage.

Example 29 includes the timing adjustment circuit of Example 27 or 28, wherein the filter circuit comprises one or more resistor-capacitor (RC) filter stages arranged in a low-pass filter configuration.

Example 30 includes the timing adjustment circuit of any one of Examples 27-29, wherein the second terminal of the capacitor is coupled to a ground terminal, the timing adjustment circuit further comprising: a resistor coupled between the second op-amp input and the ground terminal.

Example 31 includes the timing adjustment circuit of any one of Examples 27-30, wherein the first transistor is a p-channel device and the second transistor is an n-channel device.

Example 32 includes the timing adjustment circuit of any one of Examples 27-31, wherein: the second transistor turns on responsive to the voltage converter being in a high-side on phase, thereby bypassing the capacitor; and the second transistor turns off responsive to the voltage converter being in a low-side on phase.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device, or a semiconductor component. Furthermore, a voltage rail or more simply a “rail,” may also be referred to as a voltage terminal and may generally mean a common node or set of coupled nodes in a circuit at the same potential.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, such as by an end user and/or a third party.

While the use of particular transistors is described herein, other transistors (or equivalent devices) may be used instead. For example, a p-channel field effect transistor (PFET) may be used in place of an n-channel field effect transistor (NFET) with little or no changes to the circuit. Furthermore, other types of transistors may be used (such as bipolar junction transistors (BJTs)). Furthermore, the devices may be implemented in/over a silicon substrate (Si), a silicon carbide substrate (SiC), a gallium nitride substrate (GaN) or a gallium arsenide substrate (GaAs). Moreover, reference to transistor features such as gate, source, or drain is not intended to exclude any suitable transistor technologies. For instance, features such as source, drain, and gate are typically used to refer to a FET, while emitter, collector, and base are typically used to refer to a BJT. Such features may be used interchangeably herein. For instance, reference to the gate of a transistor may refer to either the gate of a FET or the base of a BJT, and vice-versa. In some examples, a control terminal may refer to either the gate of a FET or the base of a BJT. Any other suitable transistor technologies can be used. Any such transistors can be used as a switch, with the gate or base or other comparable feature acting as a switch select input that can be driven to connect the source and drain (or the emitter and collector, as the case may be).

References herein to a field effect transistor (FET) being “ON” (or a switch being closed) means that the conduction channel of the FET is present, and drain current may flow through the FET. References herein to a FET being “OFF” (or a switch being open) means that the conduction channel is not present, and drain current does not flow through the FET. A FET that is OFF, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately,” “roughly,” or “substantially” preceding a parameter means being within +/−10 percent of that parameter.

Modifications are possible in the described examples, and other examples are possible within the scope of the claims.

What is claimed is:

1. A controller configured to determine an off-time for a switching element of a power converter circuit, the controller comprising:
a pulse width modulation circuit configured to determine the off-time of the switching element based on a received feedback signal and a minimum off-time control signal, wherein the received feedback signal is proportional to a voltage at an output voltage terminal of the power converter circuit; and
a timing adjustment circuit that includes a comparator having first and second comparator inputs and a comparator output, the first comparator input configured to receive a sample voltage that changes based on the voltage at the output voltage terminal of the power converter circuit, the second comparator input configured to receive a reference voltage, and the comparator output provides the minimum off-time control signal, the comparator being configured to adjust the minimum off-time control signal based on a length of time that the sample voltage is less than the reference voltage.

2. The controller of claim 1, wherein the timing adjustment circuit further comprises a sampling block configured to generate an intermediate voltage proportional to an average of a voltage at a switching node terminal of the power converter circuit.

3. The controller of claim 2, wherein the comparator is a first comparator and the reference voltage is a first reference voltage, and the pulse width modulation circuit comprises a second comparator having a first input configured to receive the received feedback signal, a second input configured to receive a second reference voltage, and an output.

4. The controller of claim 3, wherein the pulse width modulation circuit further comprises an AND-gate having a first AND-gate input coupled to the output of the second comparator, a second AND-gate input coupled to the output of the first comparator, and an AND-gate output coupled to a pulse control block.

5. The controller of claim 2, wherein the timing adjustment circuit further comprises an amplifier configured to generate a drive current proportional to the intermediate voltage.

6. The controller of claim 5, wherein the timing adjustment circuit further comprises a current mirror arrangement configured to generate a mirrored current based on the drive current.

7. The controller of claim 6, wherein the timing adjustment circuit further comprises:
a capacitor configured to be charged by the mirrored current, and wherein a first terminal of the capacitor is coupled to both the current mirror arrangement and the first comparator input, and a second terminal of the capacitor is coupled to a ground terminal; and
a transistor coupled across the first and second terminals of the capacitor.

8. An integrated circuit comprising the controller of claim 1.

9. A voltage regulator, comprising:
a first voltage rail;
a second voltage rail;
a ground rail;
a first transistor coupled between the first voltage rail and a switching node terminal;
a first driver coupled to a control terminal of the first transistor and configured to receive a voltage on the second voltage rail;
a second transistor coupled between the switching node terminal and the ground rail;
a second driver coupled to a control terminal of the second transistor; and
a timing adjustment circuit configured to generate a minimum off-time control signal for dynamically adjusting a minimum off-time for the first transistor, the timing adjustment circuit comprising a comparator having a first input configured to receive a sample voltage that changes based on a voltage at the switching node terminal, a second input configured to receive a reference voltage, and an output that provides the minimum off-time control signal, the minimum off-time control signal having a state that is based on a length of time that the sample voltage is less than the reference voltage.

10. The voltage regulator of claim 9, wherein the timing adjustment circuit further comprises a sampling block configured to generate an intermediate voltage proportional to an average of the voltage at the switching node terminal.

11. The voltage regulator of claim 10, wherein the timing adjustment circuit further comprises an amplifier configured to generate a drive current proportional to the intermediate voltage.

12. The voltage regulator of claim 11, wherein the timing adjustment circuit further comprises a current mirror circuit configured to generate a mirrored current based on the drive current.

13. The voltage regulator of claim 12, wherein the timing adjustment circuit further comprises a capacitor configured to be charged by the mirrored current at a first terminal, and wherein the first terminal of the capacitor is coupled to the first input of the comparator and a second terminal of the capacitor is coupled to the ground rail.

14. The voltage regulator of claim 13, wherein the timing adjustment circuit further comprises a third transistor coupled across the first terminal of the capacitor and the second terminal of the capacitor.

15. The voltage regulator of claim 9, wherein the first voltage rail is an input voltage rail, the second voltage rail is a bootstrapped voltage rail, the first transistor is a high-side transistor, and the second transistor is a low-side transistor.

16. A timing adjustment circuit for use within a voltage converter, the timing adjustment circuit comprising:
a filter circuit configured to receive a switching node terminal voltage of the voltage converter and generate a direct current (DC) voltage;
an operational amplifier (op-amp) having an op-amp output and first and second op-amp inputs, the first op-amp input configured to receive the DC voltage;
a first transistor having a control terminal and first and second current terminals, the control terminal coupled to the op-amp output, and the first current terminal coupled to the second op-amp input;
a capacitor having a first terminal and a second terminal;
a current mirror circuit coupled between a voltage supply terminal and the second current terminal of the first transistor, and also coupled between the voltage supply terminal and the first terminal of the capacitor;
a second transistor coupled between the first and second terminals of the capacitor; and
a comparator having a comparator output and first and second comparator inputs, the first comparator input coupled to the first terminal of the capacitor, and the second comparator input coupled to a reference voltage source, such that the comparator output provides a logic HIGH responsive to a voltage at the first comparator input being higher than a voltage at the second comparator input, and the comparator output provides a logic LOW responsive to a voltage at the first comparator input being lower than the voltage at the second comparator input.

17. The timing adjustment circuit of claim 16, wherein the DC voltage is proportional to an average level of the switching node terminal voltage.

18. The timing adjustment circuit of claim 16, wherein the filter circuit comprises one or more resistor-capacitor (RC) filter stages arranged in a low-pass filter configuration.

19. The timing adjustment circuit of claim 16, wherein the second terminal of the capacitor is coupled to a ground terminal, the timing adjustment circuit further comprising: a resistor coupled between the second op-amp input and the ground terminal.

20. The timing adjustment circuit of claim 16, wherein: the second transistor turns on responsive to the voltage converter being in a high-side on phase, thereby bypassing the capacitor; and the second transistor turns off responsive to the voltage converter being in a low-side on phase.
